(19) United States
(12) Patent Application Publication
(10) Pub. No.: US 2009/0244469 A1
(43) Pub. Date: Oct. 1, 2009

(54) Display device for disposing driver chip with different sizes

(75) Inventors: Yu-Hsiang Lin, Hsin-Chu (TW); Kung-Yi Chan, Hsin-Chu (TW); Huan-Hsin Li, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: AU OPTRONICS CORP., Hsin-Chu (TW)

(21) Appl. No.: 12/285,749

(22) Filed: Oct. 14, 2008

(30) Foreign Application Priority Data
Mar. 28, 2008 (TW) 97111493

(51) Int. Cl. G02F 1/1345

(52) U.S. Cl. 349/149

(57) ABSTRACT

A display device includes a driver chip, a display panel, a first group of pads and a second group of pads is provided. The display panel has a glass substrate having a display region and a non-display region where the driver chip is disposed on. The display region is for displaying images under the control of the driver chip. The non-display region includes a first region and a second region that are overlapped by each other. The first group of pads is disposed on the first region and includes several first pads. The second group of pads is disposed on the second region and includes several second pads. At least a portion of the second pads are electrically connected to the according first pads. The driver chip is electrically connected to the glass substrate via one of the first group of pads and the second group of pads.

This application claims the benefit of Taiwan application Serial No. 97111493, filed Mar. 28, 2008, the subject matter of which is incorporated herein by reference.

### BACKGROUND OF THE INVENTION

1. Field of the Invention

The invention relates in general to a device, and more particularly to a display device for utilizing driver chips with different sizes.

2. Description of the Related Art

Recently, the advancing technology of display panel has brought a growing demand to portable electronic product in the market. For example, products, such as mobile phone and PDA (Personal Digital Assistant), have gradually become necessary for the customers in their daily lives.

The display panel technology is widely used in mobile products. By taking the mobile phone as an example, the mobile phone usually has a display panel with high display resolution, and is driven by a driver chip which is disposed on the substrate of the display panel. The driver chip is disposed with its chip pads electrically connected with the glass pads of the substrate to transmit the signals necessary for driving the display panel via these pads. Moreover, in order to be of the users beneficial to carry with, the mobile product also needs to possess the characteristics of lightweight, thinness, shortness and compactness. Consequently, it is usually preferred to reduce the area of the driver chip so as to shrink the volume of the mobile product.

But, when the mobile product is to utilize another chip with different size, the position of the glass pads on the substrate have to be redesigned so that the glass pads can be aligned with and connected to the chip pads. However, in order to redesign the position of the glass pads, it is needed to redesign the masks to provide a substrate with different layout patterns on which the chip with different size can then be disposed. This re-layout procedure of substrate increases the time for manufacturing, and affects the timing for outputting the product. Thus, it is an important subject to provide a display panel capable of disposing a chip with different sizes and avoiding the re-layout procedure.

### SUMMARY OF THE INVENTION

The invention is directed to a display device, which can avoid the time for re-layout procedure so that the time for manufacturing is reduced, the cost is lowered, and the associated product is capable of being available in the market quickly and becoming more competitive.

According to an aspect of the present invention, a display device is provided. The display device includes a driver chip, a display panel, a first group of pads and a second group of pads. The display panel has a glass substrate having a display region, and a non-display region where the driver chip is disposed on. The display region is for displaying images under the control of the driver chip. The non-display region includes a first region and a second region that are overlapped by each other. The first group of pads is disposed on the first region and includes several first pads. The second group of pads is disposed on the second region and includes several second pads. At least a portion of the second pads are electrically connected to the corresponding first pads. The driver chip is electrically connected to the glass substrate via one of the first group of pads and the second group of pads.

The invention will become apparent from the following detailed description of the preferred but non-limiting embodiments. The following description is made with reference to the accompanying drawings.

### BRIEF DESCRIPTION OF THE DRAWINGS

FIG. 1 is a plane view showing an example of the display device according to the embodiment of the invention.

FIG. 2 is a plane view showing the display device disposing the pads on the non-display region according to the first embodiment of the invention.

FIGS. 3A and 3B are side views each showing an example of the display device having its driver chip being connected to the glass pads on the non-display region according to the first embodiment of the invention.

FIG. 4 is a plane view showing the display device disposing the pads on the non-display region according to the second embodiment of the invention.

FIGS. 5A and 5B are side views each showing an example of the display device having its driver chip being connected to the glass pads on the non-display region according to the second embodiment of the invention.

### DETAILED DESCRIPTION OF THE INVENTION

The display device according to the invention includes a driver chip, a display panel, and a number of pads. The display panel has a glass substrate having a display region and a non-display region. The display region is for displaying images under the control of the driver chip. The driver chip is disposed on the non-display region. The non-display region includes a first region and a second region that are overlapped by each other. The pads include a first group of pads and a second group of pads. The first group of pads includes a number of first pads disposed on the first region. The second group of pads includes a number of second pads disposed on the second region. At least a portion of the second pads is electrically connected to the corresponding first pads. The driver chip is electrically connected to the glass substrate via one of the first group of pads and the second group of pads. The display device of the invention will be illustrated by two exemplary embodiments in the following.

### First Embodiment

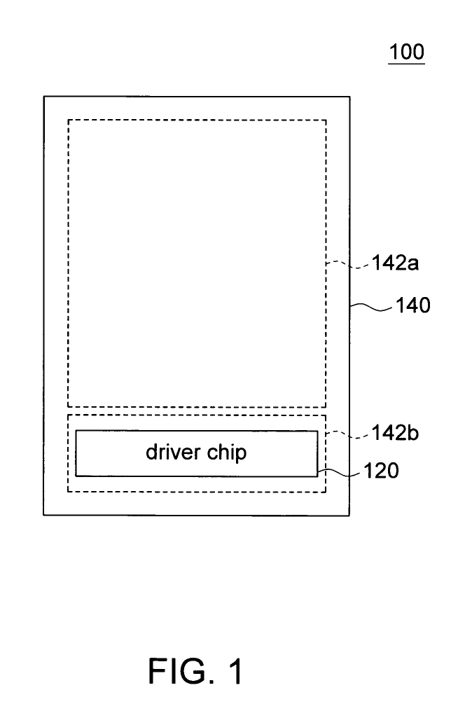

FIG. 1 is a plane view showing an example of the display device according to the embodiment of the invention. Referring to FIG. 1, the display device 100 includes a driver chip 120 and a display panel 140. The display panel 140 at least includes a glass substrate. For example, when the display panel 140 is a liquid crystal display panel, the liquid crystal display panel may include a thin film transistor substrate, a color filter substrate, and a liquid crystal layer. The liquid crystal layer is sandwiched between the thin film transistor substrate and the color filter substrate. The above-mentioned glass substrate can be the thin film transistor substrate or the color filter substrate. Preferably, the glass substrate is the thin film transistor substrate.

The glass substrate includes a display region 142a and a non-display region 142b. The display region 142a is for displaying images under the control of the driver chip 120 that is disposed on the non-display region 142b. The glass pads are disposed on the non-display region 142b. The driver chip 120 is electrically connected to the glass substrate via glass pads disposed on the non-display region.

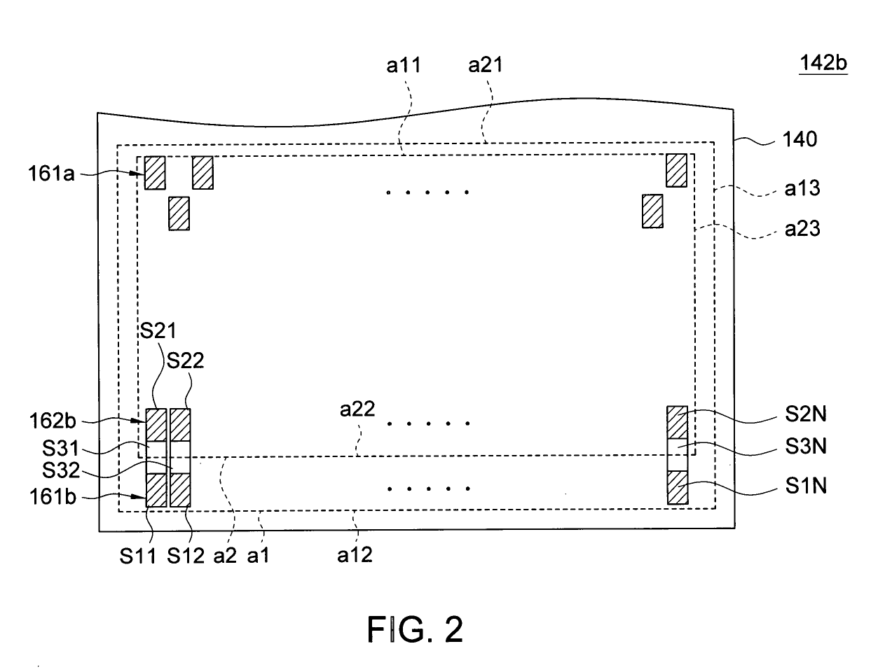

The configuration of disposing these glass pads according to the embodiment of the invention will be illustrated in the following. FIG. 2 is a plane view showing the display device disposing the pads on the non-display region according to the first embodiment of the invention. Referring to FIG. 2, the glass pads disposed on the non-display region 142b of the glass substrate include a first group of pads and a second group of pads that are disposed on the first region a1 and the second region a2 of the non-display region 142b, respectively. In FIG. 2, it is illustrated that the second region a2 is located within the first region a1. The area of the second region a2 is smaller than the area of the first region a1.

In this embodiment, the first group of pads includes a sub-group of pads 161a and a sub-group of pads 161b. The second group of pads includes the sub-group of pads 161a and a sub-group of pads 162b. The sub-group of pads 161a in this embodiment is shared by the first group of pads 161 and the second group of pads 162.

Preferably, the first region a1 and the second area a2 are substantially rectangular in shape. The first region a1 has longer side all, a12, and at least a shorter side a13, and the second region a2 also has longer side a21, a22, and at least a shorter side a23. The length of the shorter side a23 of the second region a2 is shorter than the length of the shorter side a13 of the first region a1. In an example, the longer side all of the first region a1 is substantially overlapped with the longer side a21 of the second region a2.

The sub-group of pads 161a is disposed along the longer side a21; the sub-group of pads 162b is disposed along the longer side a22; the sub-group of pads 161b is disposed along the longer side a12. The pads of the sub-group of pads 161b are electrically connected to the corresponding pads of the sub-group of pads 162b. For example, the sub-group of pads 161b includes pads S11˜S1N, and the sub-group of pads 162b includes pads S21˜S2N. The pads S11˜S1N are electrically connected to the pads S21˜S2N, respectively.

Electrically connecting the pads of the sub-group of pads 161b to the corresponding pads of the sub-group of pads 162b can be achieved by using a number of ways. For example, it can be achieved by way of using a trace to electrically connect the two corresponding pads to each other, or by way of extending the length of one of the two pads to electrically connect to the other one of the two pads. In FIG. 2, it is illustrated by extending the length of pads of the sub-group of pads 162b to electrically connect to the pads of the sub-group of pads 161b. In FIG. 2, the sub-group of pads 162b is extended out of the second region a2 and to the first region a1, and is electrically connected to the corresponding sub-group of pads 161b. For example, in the above-mentioned example, the pads S21, S22 . . . S2N of sub-group of pads 162b have extending parts S31, S32 . . . S3N, respectively, extending out of the second region a2 and being electrically connected to the pads S11, S12 . . . S1N of the sub-group of pads 161b on the first region a1.

It is known that the location of disposing the chip pads relates to the available size of the driver chip 120. In this embodiment, the glass chips for bearing the chip pads include two groups of pads, that is, the first and second group of pads, so that the driver chip 120 can be electrically connected to the glass substrate via one of the first and the second group of pads. As a result, the display device 100 can have a driver chip 120 corresponding to the first group of pads, or a driver chip 120 corresponding to the second group of pads to be disposed on the glass substrate, which makes a single glass substrate capable of utilizing driver chips 120 with different sizes.

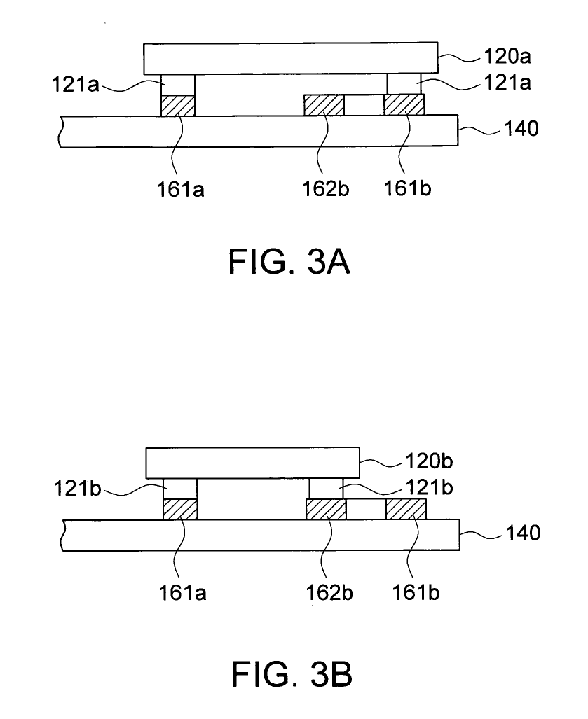

FIGS. 3A and 3B are side views each showing an example of the display device having its driver chip being connected to the glass pads on the non-display region according to the first embodiment of the invention. Referring to FIGS. 3A and 3B, with different sizes, the driver chips 120a and 120b have a number of chip pads 121a and 121b, respectively. The driver chip 120a can be electrically connected to the glass substrate via the sub-group of pads 161a and 161b of the first group of pads 161. The driver chip 120b can be electrically connected to the glass substrate via the sub-group of pads 161a and 162b of the second group of pads 162. Thus, it is shown in this embodiment that by disposing a number of groups of pads on different regions, the display device 100 can have a driver chip with different sizes being disposed on the glass substrate.

After a conventional display panel has been developed, if a display device is desired to have a driver chip with different size to be disposed on the display panel, it is required to manufacture a new display panel having the glass pads with different layout, and to re-redesign the masks that affects the procedure of making product. In this embodiment, the first group of pads and the second group of pads can also be formed during the same procedure of manufacturing the display panel 140. Therefore, when the display panel 140 has been produced, one of the two groups of pads can be selected to be connected to the driver chip. Then, if the display panel is designed to utilize another driver chip with different size, the other one of the two groups of pads can be selected to be connected to the driver chip. Therefore, in this embodiment, the re-layout procedure can be avoided, so that the time for manufacturing is reduced, the cost is lowered, and the associated product is capable of being available in the market quickly and making the product more competitive.

Besides, in this embodiment, the design for the pads arrangement corresponds to that of the chips pads of the driver chip. When the chip pads of the driver chip are interlaced, the corresponding pads in this embodiment will be interlaced in the same way. For example, as shown in FIG. 2, the sub-group of pads 161a is disposed on the glass substrate in interlaced arrangement so as to be electrically connected to the chip pads of the driver chip. However, the invention is not particularly limited thereto. These pads, such as the sub-group of pads 161a and 162b, can also be disposed on the glass substrate with equal interval between two adjacent pads. In application, the glass pads to which the driver chip is connected can be disposed according to chip pads arrangement of different driver chips.

Moreover, in this embodiment, the sub-group of pads 161b and 162b are for receiving various signals, such as the horizontal clock signal (HCK), the vertical clock signal (VCK), and the master clock, that are transmitted from an external circuit board to the driver chip 120. On the other hand, the sub-group of pads 161a is coupled to the display area 142a, and is for outputting various signals, such as the scan signals and the data signals that are transmitted by the driver chip 120 to the display panel 140.

The display panel according to the embodiment of the invention is illustrated by disposing two groups of pads on two different regions, which is taken as an example for the sake of illustration. However, the invention is not limited thereto. It is also accepted to dispose more than two groups of pads on a number of different regions that are overlapped by each other, so as to increase the number of driver chips with different sizes which can be choose to utilize.

### Second Embodiment

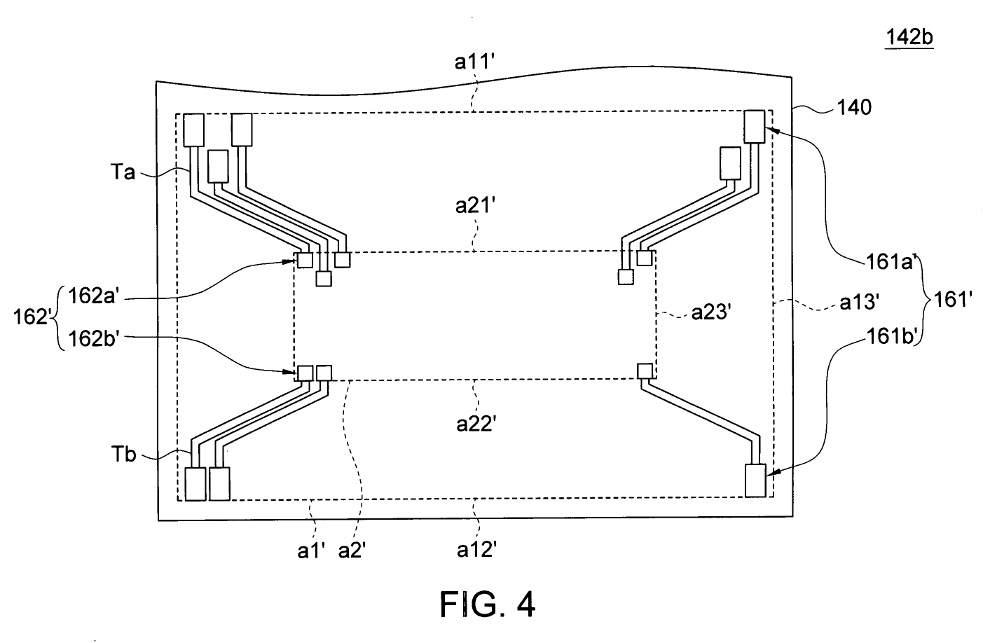

FIG. 4 is a plane view showing the display device disposing the pads on the non-display region according to the second embodiment of the invention. This embodiment is different from the first embodiment in the following ways. The first group of pads 161′ includes sub-group of pads 161a′ and 161b′, and the second group of pads 162′ includes sub-group of pads 162a′ and 162b′. In addition, the two longer sides a21′ and a22′ of the second region a2′ are located between the two longer sides a11′ and a12′ of the first region a1′.

Besides, in the first embodiment, the sub-group of pads 162b′ are electrically connected to the sub-group of pads 161b′ by way of extending pads lengths. In this embodiment, the pads of the sub-group of pads 162b′ are electrically connected to the corresponding pads of the sub-group of pads 161b′ by a number of traces Tb. Similarly, the pads of the sub-group of pads 162a′ are electrically connected to the corresponding pads of the sub-group of pads 161a′ by a number of traces Ta.

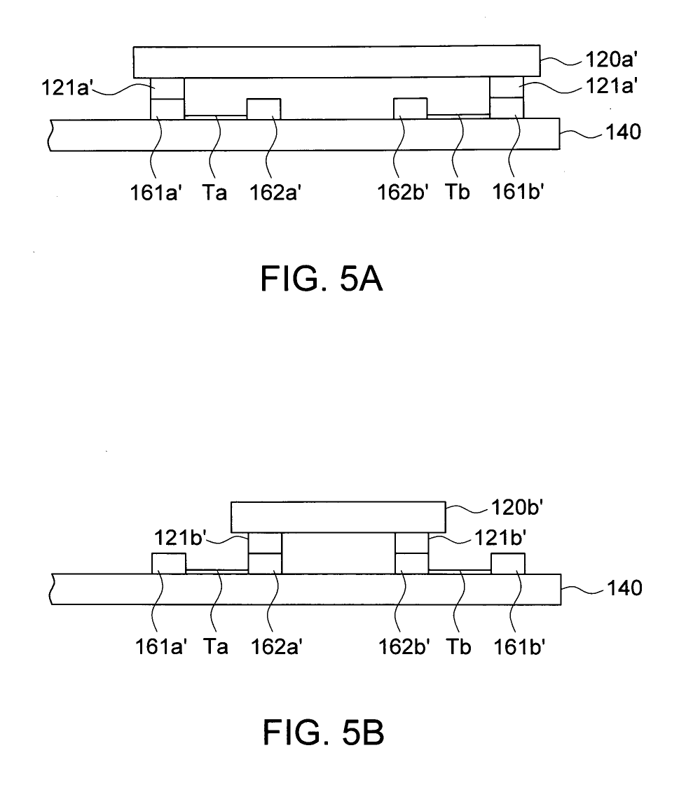

FIGS. 5A and 5B are side views each showing an example of the display device having its driver chip being connected to the glass pads on the non-display region according to the second embodiment of the invention. The driver chips 120a′ and 120b′ have a number of chip pads 121a′ and 121b′, respectively. The driver chip 120a′ can be electrically connected to the glass substrate via the sub-group of pads 161a′ and 161b′ of the first group of pads 161′. The driver chip 120b′ can be electrically connected to the glass substrate via the sub-group of pads 162a′ and 162b′ of the second group of pads 162′. Thus, in this embodiment, the display device 100 can have driver chips with different sizes being disposed on the glass substrate.

In this embodiment, because the two longer sides a21′ and a22′ of the second region a2′ are located between the two longer sides a11′ and a12′ of the first region a1′, the lengths of the longer sides a21′ and a22′ can be shorter than the lengths of the longer sides a11′ and a12′. As a result, in comparison with the display device 100 in the first embodiment that only the length of the shorter side a23′ is changeable, the lengths of both of the longer side and shorter side of the second region a2′ are changeable in the display device 100 in this embodiment. Therefore, the display device in this embodiment can have driver chips with different longer side lengths to be disposed on.

The display panel according to the above-mentioned embodiments of the invention can, preferably, be applied to the portable electronic devices, such as mobile phone and PDA.

The display panel disclosed in the above-mentioned embodiments of the invention has following advantages. Because driver chips with different sizes can be utilized on the display panel, it is more flexible for the designers to select the driver chip. Also, the display panels according to the embodiments can use the glass substrates of same type with different driver chips of different sizes to meet different clients' needs, so as to render the design for the product more diversified.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display device, comprising:
a driver chip;
a display panel having a glass substrate, the glass substrate having a display region and a non-display region, the driver chip being disposed on the non-display region, the display region being for displaying images under the control of the driver chip, the non-display region comprising a first region and a second region, the first region and the second region being overlapped by each other;
a first group of pads disposed on the first region, the first group of pads having a plurality of first pads; and
a second group of pads disposed on the second region, the second group of pads having a plurality of second pads, at least a portion of the second pads being electrically connected to the corresponding first pads;
wherein the driver chip is electrically connected to the glass substrate via one of the first group of pads and the second group of pads.

2. The display device according to claim 1, wherein the first second is located within the second region.

3. The display device according to claim 1, wherein the area of the second region is smaller than the area of the first region.

4. The display device according to claim 3, wherein both of the first region and the second region are rectangular in shape, a portion of the second pads is disposed along a first longer side of the second region, the other portion of the second pads is disposed along a second longer side of the second region and is electrically connected to the corresponding first pads, a third longer side of the first region is substantially overlapped with the first longer side of the second region, and the length of the shorter side of the second region is shorter than the length of the shorter side of the first region.

5. The display device according to claim 3, wherein both of the first region and the second region are rectangular in shape, the first group of pads comprises a first sub-group of pads and a second sub-group of pads, the first sub-group of pads is disposed along a longer side of the first region, the second sub-group of pads is disposed along the other longer side of the first region, the second group of pads comprises a third sub-group of pads and a forth sub-group of pads, the third sub-group of pads is disposed along a longer side of the second region, the forth sub-group of pads is disposed along the other longer side of the second region, the two longer sides of the second region are located between the two longer sides of the first region, the length of the shorter side of the second region is shorter that that of the first region.

6. The display device according to claim 5, wherein the length of the longer side of the second region is shorter than the length of the longer side of the first region.

7. The display device according to claim 5, wherein the pads of the same sub-group of pads are disposed with equal interval between two adjacent pads along the corresponding longer side.

8. The display device according to claim 3, wherein a portion of the first pads are interlaced.

9. The display device according to claim 3, wherein a portion of the second pads are interlaced.

10. The display device according to claim 3, wherein at least a portion of the second pads is extended out of the second region and to the first region.

11. The display device according to claim 3, wherein at least a portion of the second pads are electrically connected to the corresponding first pads through corresponding traces individually.

12. The display device according to claim 3, wherein the display panel is a liquid crystal display panel.
